(19) United States
(12) Patent Application Publication
(10) Pub. No.: US 2004/0194806 A1
(43) Pub. Date: Oct. 7, 2004

(54) IPA concentration interlock detector for substrate dryer

(75) Inventors: Shin-Shing Yang, Yung Kang City (TW); Liang-Yi Chou, Yung Kang City (TW); Jenn-Wei Ju, Taiping City (TW); Juan-Chin Cheng, Fengshan City (TW); Fu-Shiang Chen, Tainan (TW); Chun-Ying Chen, Taichung (TW); Li-Te Hsu, Tainan (TW); Chia-Lun Chen, Hsinchu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/406,726

(22) Filed: Apr. 2, 2003

(51) Int. Cl. B08B 7/04

(52) U.S. Cl. 134/18; 134/35; 134/34; 134/56 R; 134/95.2; 134/105

(57) ABSTRACT

A substrate drying system having an IPA concentration interlock detector for detecting the concentration of substrate-drying IPA vapor in a processing or cleaning tank of a Marongoni-type substrate drying system, for example, as substrates are dried in the cleaning tank after washing typically using deionized water. In the event that inadequate concentrations of the IPA vapor are delivered to the cleaning tank, the IPA concentration interlock detector transmits an alarm signal to the tool controller to alert facility personnel to the inadequate IPA concentrations in the cleaning tank and prevent the formation of water marks on the substrates.

### FIELD OF THE INVENTION

The present invention relates to systems for drying semiconductor wafer substrates after cleaning in the fabrication of semiconductor integrated circuits. More particularly, the present invention relates to a new and improved IPA concentration interlock detector for the prevention of water residue or mark formation on substrates during drying of the substrates in a substrate drying system.

### BACKGROUND OF THE INVENTION

Generally, the process for manufacturing integrated circuits on a silicon wafer substrate typically involves deposition of a thin dielectric or conductive film on the wafer using oxidation or any of a variety of chemical vapor deposition processes; formation of a circuit pattern on a layer of photoresist material by photolithography; placing a photoresist mask layer corresponding to the circuit pattern on the wafer; etching of the circuit pattern in the conductive layer on the wafer; and stripping of the photoresist mask layer from the wafer. Each of these steps, particularly the photoresist stripping step, provides abundant opportunity for organic, metal and other potential circuit-contaminating particles to accumulate on the wafer surface.

In the semiconductor fabrication industry, minimization of particle contamination on semiconductor wafers increases in importance as the integrated circuit devices on the wafers decrease in size. With the reduced size of the devices, a contaminant having a particular size occupies a relatively larger percentage of the available space for circuit elements on the wafer as compared to wafers containing the larger devices of the past. Moreover, the presence of particles in the integrated circuits compromises the functional integrity of the devices in the finished electronic product. Currently, mini-environment based IC manufacturing facilities are equipped to control airborne particles much smaller than 1.0 μm, as surface contamination continues to be of high priority to semiconductor manufacturers. To achieve an ultra-clean wafer surface, particles must be removed from the wafer, and particle-removing methods are therefore of utmost importance in the fabrication of semiconductors.

The most common system for cleaning semiconductor wafers during wafer processing includes a series of tanks which contain the necessary cleaning solutions and are positioned in a “wet bench” in a clean room. Batches of wafers are moved in sequence through the tanks, typically by operation of a computer-controlled automated apparatus. Currently, semiconductor manufacturers use wet cleaning processes which may use cleaning agents such as deionized water and/or surfactants. Other wafer-cleaning processes utilize solvents, dry cleaning using high-velocity gas jets, and a megasonic cleaning process, in which very high-frequency sound waves are used to dislodge particles from the wafer surface. Cleaning systems which use deionized (DI) water currently are widely used in the industry because the systems are effective in removing particles from the wafers and are relatively cost-efficient. Approximately 4.5 tons of water are used for the production of each 200-mm, 16-Mbit, DRAM wafer. In the final process tank, the water and other rinse fluid is removed from the wafer surface using a solvent such as isopropyl alcohol (IPA). IPA is an organic solvent known to reduce the surface tension of water.

In one type of IPA drying method, wet substrates are moved into a sealed vessel and placed in the processing region of the vessel. An IPA vapor cloud is generated in a vapor-generating region of the vessel and is directed into the processing region, where it removes water from the wafers. This drying technology is highly effective in removing liquid from the wafers, but is not easily adaptable to single vessel systems in which chemical processing, rinsing, and drying can be carried out in a single vessel.

Environmental concerns have given rise to efforts to improve drying technology in a manner that minimizes IPA usage. One such improved drying technology is the Marongoni technique. In one application of the Marongoni technique, an IPA vapor is condensed on top of the rinse water containing the wafers while the wafers are slowly lifted from the processing vessel. The concentration of the dissolved vapor is highest at the wafer surfaces and lower at the regions of the rinse fluid that are spaced from the wafer surfaces. Because surface tension decreases as IPA concentration increases, the surface tension of the water is lowest at the wafer surface where the IPA concentration is highest. The concentration gradient thus results in “Marongoni flow” of the rinse water away from the surfaces of the wafers. Rinse water is thereby stripped from the wafer surfaces, leaving the wafer surfaces dry.

One example of a conventional Marongoni substrate drying system 10 which employs the Marongoni technique is illustrated schematically in FIG. 1. The system 10 includes an IPA container 12 which contains a supply of isopropyl alcohol. A valve 15 is provided between an IPA outlet line 14 which leads from the IPA container 12 and an IPA transfer line 16 which leads to a substrate cleaning tank 18. A nitrogen gas supply 20 is provided in fluid communication with the IPA transfer line 16 through a nitrogen flow line 22, which is typically fitted with a valve 24, a filter 26 and a flow meter 28. The nitrogen gas supply 20 is typically further provided in fluid communication with the IPA container 12 through a second nitrogen flow line 22a, typically fitted with a valve 24a, a filter 26a and a flow meter 28a.

In a substrate drying process using the Marongoni substrate drying system 10, a substrate (not shown) is first rinsed in the substrate cleaning tank 18 using DI (deionized) water. Next, nitrogen gas is distributed from the nitrogen gas supply 20 to the IPA transfer line 16 through the nitrogen flow line 22, while IPA vapor is distributed from the IPA container 12 to the IPA transfer line 16 through the IPA outlet line 14 and valve 15. The IPA vapor mixes with the nitrogen gas in the IPA transfer line 16, and is introduced into the substrate cleaning tank 18. A meniscus-shaped gradient is formed along the interface between the surface of the substrate and the DI water, and as the substrate is removed from the substrate cleaning tank 18, the water flows along the meniscus portion and is thereby removed from the substrate, with no water remaining on the substrate upon complete removal of the substrate from the tank 18.

During the drying operation of the conventional Marongoni substrate drying system 10 heretofore described, under normal circumstances the IPA vapor is carried by nitrogen gas from the IPA container 12, through the IPA transfer line 16 and to the substrate cleaning tank 18 typically at atmospheric pressure. However, the filter 26a has a tendency to become clogged by IPA after prolonged use, preventing or hindering flow of the carrier nitrogen gas from the nitrogen gas supply 20 to the IPA container 12. Consequently, the IPA vapor is incapable of flowing with the nitrogen gas from the IPA container 12 to the substrate cleaning tank 18, resulting in inadequate concentrations of the IPA in the substrate cleaning tank 18. Other common causes of inadequate concentration of IPA in the substrate cleaning tank 18 include breakage of the N₂/IPA-N₂ connector of the cleaning tank lid, thereby causing inadequate opening of the valves 24, 24a. Inadequate concentrations of IPA in the substrate cleaning tank 18 results in inadequate drying of the substrates therein, forming water marks or residues on the substrates. This adversely affects the yield of devices on the substrates and frequently necessitates the scrapping, or elimination, of substrates being dried in the substrate cleaning tank 18. Accordingly, an IPA concentration detecting system is needed for detecting or monitoring the concentration of the IPA in a substrate cleaning tank during the drying of substrates therein and automatically terminating operation of the substrate drying system in order to avoid scrapping of the substrates in the cleaning tank.

An object of the present invention is to provide a substrate drying system having an IPA (isopropyl alcohol) concentration detector for detecting concentrations of IPA in a cleaning tank for substrates.

Another object of the present invention is to provide a substrate drying system in which levels of IPA can be detected in order to avoid excessively high or excessively low levels of the IPA in a cleaning tank of a substrate drying system.

Yet another object of the present invention is to provide a substrate drying system having an IPA concentration interlock detector which prevents formation of water marks on substrates induced by inadequate concentrations of IPA (isopropyl alcohol) in the cleaning tank of the system.

Still another object of the present invention is to provide an IPA concentration interlock detector for detecting abnormal concentrations of IPA in a substrate drying system as the vaporized IPA enters the cleaning tank of the system and alerting facility personnel to the abnormal IPA concentrations in the tank in order to prevent wafer scrapping.

Another object of the present invention is to provide an IPA concentration interlock detector which may be adapted for use in Marongoni-type substrate drying systems for drying substrates.

Yet another object of the present invention is to provide a temperature control system for controlling the concentration of IPA in a cleaning tank of a substrate drying system for optimal drying of substrates.

A still further object of the present invention is to provide a temperature control system which may adapted to control the temperature and concentration of IPA vapor in a Marongoni-type substrate drying system.

### SUMMARY OF THE INVENTION

In accordance with these and other objects and advantages, the present invention is generally directed to a substrate drying system having an IPA concentration interlock detector for detecting the concentration of substrate-drying IPA vapor in a processing or cleaning tank of a Marongoni-type substrate drying system, for example, as substrates are dried in the cleaning tank after washing typically using deionized water. In the event that inadequate concentrations of the IPA vapor are delivered to the cleaning tank, the IPA concentration interlock detector transmits an alarm signal to the tool controller to alert facility personnel to the inadequate IPA concentrations in the cleaning tank and prevent the formation of water marks on the substrates.

In another embodiment, the substrate drying system is provided with a temperature control system for controlling the temperature, and thus, the concentration of the IPA before the IPA vapor is delivered to the cleaning tank. The IPA tank of the substrate drying system is fitted with a heater that heats the IPA vapor before the IPA vapor is distributed to the cleaning tank. An IPA concentration detector that measures the concentration of the IPA in the cleaning tank is operably connected to a temperature control mechanism which controls the temperature of the IPA tank to facilitate the desired concentrations of the IPA in the cleaning tank.

### BRIEF DESCRIPTION OF THE DRAWINGS

The invention will now be described, by way of example, with reference to the accompanying drawings, in which:

FIG. 1 is a schematic view of a typical conventional Marongoni-type substrate drying system;

FIG. 2 is a schematic view of a substrate drying system with IPA concentration interlock detector in implementation of the present invention;

FIG. 3 is a top view, partially schematic, of a substrate drying tank of the substrate drying system of FIG. 2;

FIG. 4 is a schematic view of a substrate drying system with IPA temperature control system in implementation of the present invention; and

FIG. 5 is an illustrative electrical schematic diagram for the IPA temperature control system of FIG. 4.

### DESCRIPTION OF THE PREFERRED EMBODIMENTS

The present invention is generally directed to a substrate drying system having an IPA (isopropyl alcohol) concentration interlock detector which detects abnormal concentrations of a substrate-drying IPA vapor in a processing or cleaning tank of a Marongoni-type substrate drying system, for example, as substrates are dried in the cleaning tank after washing typically using deionized water. In the event that abnormally high or low concentrations of the IPA vapor are delivered to the cleaning tank, the IPA concentration interlock detector signals an alarm to alert facility personnel to the excessive or inadequate IPA concentrations in the cleaning tank.

In another embodiment, the substrate drying system is provided with a temperature control system for controlling the temperature, and thus, the concentration of the IPA before the IPA vapor is delivered to the cleaning tank. The IPA tank of the substrate drying system is fitted with a heater that heats the IPA vapor before the IPA vapor is distributed to the cleaning tank. An IPA concentration detector that measures the concentration of the IPA in the cleaning tank is operably connected to a temperature control mechanism which controls the temperature of the IPA tank to facilitate the desired concentrations of the IPA in the cleaning tank. While IPA is described as the drying vapor in the present application, it is understood that either embodiment of the present invention may be applicable to substrate drying systems which use alternative drying fluids other than IPA.

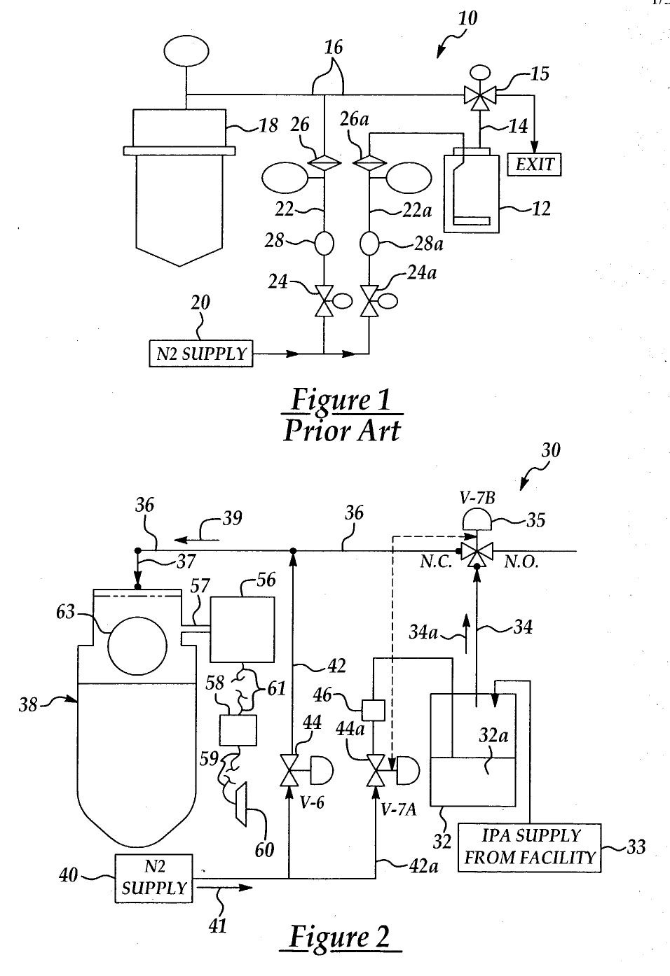

Referring to FIG. 2, a substrate drying system 30, in implementation of the present invention, is available from Steag Microtech of Donaueschingen, Denmark and employs the Marongoni drying technique to dry substrates 63. The Steag Marongoni substrate drying system 30 includes an IPA container 32 which receives liquid IPA (isopropyl alcohol) 32a from an IPA supply 33. A valve 35 is provided between an IPA outlet line 34 which leads from the IPA container 32 and an IPA transfer line 36 which leads to a substrate cleaning tank 38 through an IPA inlet line 37. A nitrogen gas supply 40 is provided in fluid communication with the IPA transfer line 36 through a nitrogen flow line 42, which is typically fitted with a valve 44. The nitrogen gas supply 40 is typically further provided in fluid communication with the IPA container 32 through a second nitrogen flow line 42a, typically fitted with a valve 44a and a filter 46.

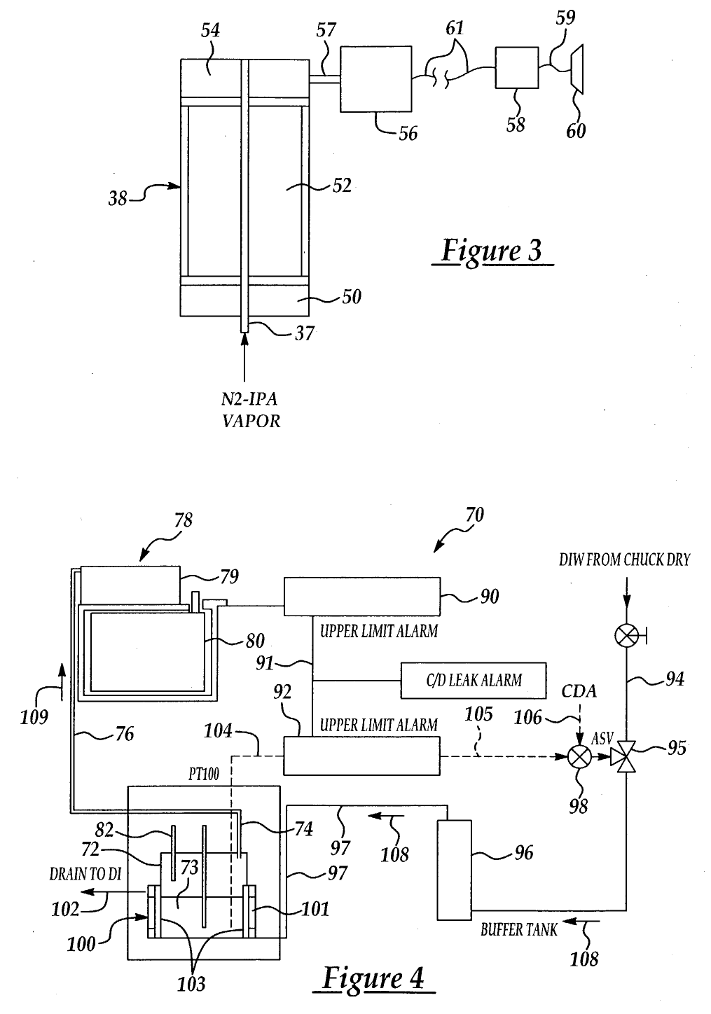

As shown in FIG. 3, the substrate cleaning tank 38 typically includes a tank lid 50; a substrate processing portion 52; and a rear portion 54. The substrate processing portion 52 receives a load of substrates 63 (FIG. 2) for washing the substrates 63 using deionized water followed by drying of the substrates 63 using the Marongoni technique. An IPA concentration detector 56 is provided in fluid communication with the substrate cleaning tank 38, typically with the rear portion 54 thereof, as shown in FIG. 3, through an IPA vapor conduit 57. The IPA concentration detector 56 may be any type of vapor concentration detector which is known by those skilled in the art and capable of detecting the concentration of IPA vapor in the rear portion 54 of the substrate cleaning tank 38. The IPA concentration detector 56 is connected to a microprocessor 58 through wiring 61. The microprocessor 58 is, in turn, connected through wiring 59 to a suitable alarm 60, which notifies facility personnel to the abnormally low or abnormally high concentration of IPA vapor in the substrate cleaning tank 38, as hereinafter described. The microprocessor 58 receives electronic signals from the IPA concentration detector 56, which signals indicate the concentration of the IPA in the rear portion 54 of the substrate cleaning tank 38. The microprocessor 58 is programmed according to the knowledge of those skilled in the art to activate the alarm 60 in the event that the IPA vapor concentration in the rear portion 54 falls below a predetermined lower limit, for example, 4,000 ppm. The microprocessor 58 may also be programmed to activate the alarm 60 in the event that the IPA vapor concentration in the rear portion 54 rises above a predetermined upper limit, for example, 16,000 ppm, since IPA vapor concentration rising above that limit may increase the possibility of an explosion due to the flammable IPA vapor.

Referring again to FIG. 2, in a substrate drying process using the Marongoni substrate drying system 30, a substrate 63 is first rinsed in the wafer processing portion 52 of the substrate cleaning tank 38 using DI (deionized) water. Next, nitrogen gas 41 is distributed from the nitrogen gas supply 40 to the IPA transfer line 36 through the nitrogen flow line 42, while IPA vapor 34a is distributed from the IPA container 32 to the IPA transfer line 36 through the IPA outlet line 34 and valve 35. The IPA vapor 34a mixes with the nitrogen gas 41 in the IPA transfer line 36, and the nitrogen-IPA vapor 39 is introduced into the substrate cleaning tank 38 through the IPA inlet 37. A meniscus-shaped gradient (not shown) is formed along the interface between the surface of the substrate and the DI water, and as the substrate is removed from the substrate cleaning tank 38, the water flows along the meniscus portion and is thereby removed from the substrate, with no water remaining on the substrate upon complete removal of the substrate from the tank 38.

Referring again to FIG. 3, during the substrate drying process carried out in the cleaning chamber 38, the IPA vapor may be present in the rear portion 54 in a concentration of up to about 20,000 ppm (parts per million). In the event that the concentration of the nitrogen-IPA vapor in the rear portion 54 drops below the lower limit programmed into the microprocessor 58, for example, typically about 4000 ppm as measured by the IPA concentration detector 56, then the microprocessor 58 activates the alarm 60, which notifies facility personnel to the inadequate IPA vapor levels in the substrate cleaning tank 38 for optimal drying of the substrates 63. Such a reduction in the IPA vapor concentration may indicate the presence of a leak in the valve 44a or valve 35; clogging of the filter 46 in the nitrogen flow line 42a, which would prevent the carrier nitrogen gas 41 from combining with the IPA vapor 34a in the IPA container 32 and carrying the IPA vapor 34a to the substrate cleaning tank 38; cracked or loose tubing in the drying system 30, which would cause leakage of the nitrogen gas 41, IPA vapor 34a and/or nitrogen-IPA vapor 39 from the substrate drying system 30; and/or cracking and leakage of the dryer lid 50, which would cause leakage of the nitrogen-IPA vapor 39 from the substrate cleaning tank 38. Accordingly, facility personnel may then terminate operation of the substrate drying system 70 and take appropriate corrective measures to replace and/or repair any or all of these elements in order to restore adequate concentrations of the nitrogen-IPA vapor 39 in the substrate cleaning tank 38.

Another embodiment of a substrate drying system 70 in implementation of the present invention is shown in FIG. 4, in which many of the conventional components of the substrate drying system 70 have been omitted for brevity. In the substrate drying system 70, which may be a Marongoni-type substrate drying system available from Steag Microtech of Donaueschingen, Denmark, a temperature controller 92 is provided in combination with an IPA concentration detector 90 to maintain optimal and stable concentrations of IPA vapor in a substrate cleaning tank 78. The substrate drying system 70 includes an IPA container 72 which contains liquid IPA (isopropyl alcohol) 73 received from an IPA supply (not shown). An IPA outlet line 74 leads from the IPA container 72 to an IPA transfer line 76, which receives a supply of nitrogen gas (not shown) that combines with the vaporized IPA and distributes the nitrogen-IPA vapor 109 to the lid 79 of the substrate cleaning tank 78, which includes a substrate processing portion 80. The IPA container 72 receives nitrogen gas through a nitrogen flow line 82.

A typically C-shaped heating ring 100, provided with heating elements 101, encircles the bottom portion of the IPA container 72 for purposes which will be hereinafter described. A heat-conducting collar 103, which may be rubber, is interposed between the inner surface of the heating ring 100 and the outer surface of the IPA container 72. One end of the heating ring 100 is provided in confluent communication with a water inlet line 97, which receives a stream of heated deionized water from a DI water line 94, and a water outlet line 102 extends from the opposite end of the heating ring 100. A temperature buffer tank 96 may be provided between the DI water line 94 and the inlet line 97. A water flow valve 95 is provided in the DI water line 94 for controlling the flow of heated DI water through the DI water line 94. Accordingly, DI water 108 is capable of flowing from the DI water line 94, through the temperature buffer tank 96, inlet line 97, heating ring 100 and water outlet line 102, respectively, in order to heat the liquid IPA 73 in the IPA container 72 to a selected temperature and achieve a desired concentration of the IPA vapor 109 in the substrate cleaning tank 78, as hereinafter described.

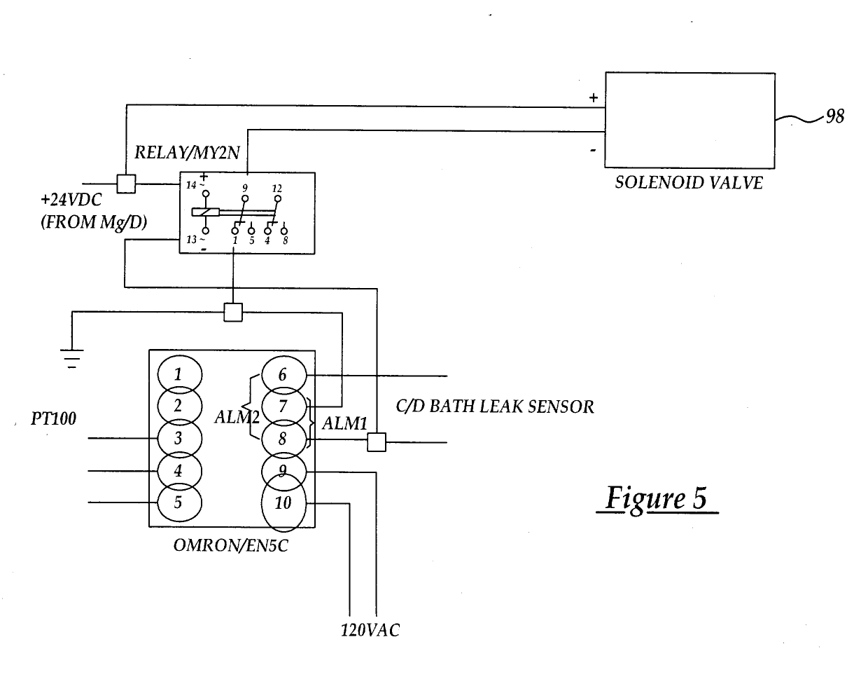

An IPA concentration detector 90, such as the IPA concentration detector 56 heretofore described with respect to the embodiment of FIGS. 2 and 3, is confluently connected to the substrate cleaning tank 78 for detecting the concentration of IPA vapor therein. The IPA concentration detector 90 is further connected, through wiring 91, to a temperature controller 92 such as an OMRON model E5CN temperature controller. The temperature controller 92 is connected through suitable wiring 104 to the heating elements 101 of the heating ring 100. The temperature controller 92 may be further operably connected to a solenoid valve 98 that is, in turn, connected to the water flow valve 95. As hereinafter described, the temperature controller 92 is capable of transmitting an electrical signal 105 to the solenoid valve 98, which establishes flow of an air signal 106 to the water flow valve 95 to close the water flow valve 95. An illustrative electrical schematic diagram for the substrate drying system 70 is shown in FIG. 5.

In operation of the substrate drying system 70, the temperature controller 92 maintains the temperature of the liquid IPA 73 in the IPA container 72 within a desired temperature range, typically from about 18° C. to about 30° C., to maintain a stable concentration of the vaporized IPA 109 in the substrate processing portion 80 of the substrate cleaning tank 78. Accordingly, heated DI water 108 is distributed through the DI water line 94 through the open water flow valve 95; the temperature buffer tank 96, which maintains stability in the temperature of the DI water 108; through the inlet line 97; and through the heating ring 100, from which the water outlet line 102 distributes the DI water 108. As the water passes through the heating ring 100, the heating elements 101 heat and maintain the DI water 108 to the selected temperature, such that the heat is transferred from the circulating water 108, through the heat-conducting collar 103 and to the liquid IPA 73 in the IPA container 72, respectively. Accordingly, the heated liquid IPA 73 vaporizes at an accelerated rate in the IPA container 72, and is distributed through the IPA outlet line 74 and the IPA transfer line 76, where the vaporized IPA combines with nitrogen gas to form a nitrogen-IPA vapor 109 mixture. The nitrogen-IPA vapor 109 is then distributed into the substrate cleaning tank 78, where substrates (not shown) in the substrate processing portion 80 thereof are dried using the Marongoni technique.

The IPA concentration detector 90 continually monitors the concentration of the vaporized IPA 109 in the substrate cleaning tank 78, and electrical signals corresponding to the IPA concentration are transmitted from the IPA concentration detector 90 to the temperature controller 90. Normally, the temperature controller 92 is set to maintain the temperature of the liquid IPA 73 in the IPA container 72 at a temperature of from about 18° C. to about 30° C., to maintain a stable concentration of the vaporized IPA 109 in the substrate processing portion 80 of the substrate cleaning tank 78. However, in the event that the concentration of the vaporized IPA 109 in the substrate cleaning tank 78 rises above a selected upper limit, for example, 20,000 ppm, as measured by the IPA concentration detector 90, the temperature controller 92 may automatically terminate flow of the DI water 108 through the heating ring 100 in order to partially cool the liquid IPA 73 and drop the concentration of the vaporized IPA 109 to a level below the upper concentration limit. The temperature controller 92 terminates flow of DI water 108 to the heating ring 100 by closing the DI water line 94 via the water flow valve 95. This is accomplished by the transmission of an electronic signal 105 from the temperature controller 92 to the solenoid valve 98, thereby opening the solenoid valve 98 to permit flow of an air signal 106 to the water flow valve 95, thereby closing the water flow valve 95 and terminating flow of the DI water to the heating ring 100.

While the preferred embodiments of the invention have been described above, it will be recognized and understood that various modifications can be made in the invention and the appended claims are intended to cover all such modifications which may fall within the spirit and scope of the invention.

What is claimed is:

1. A system for drying a substrate, comprising:
a substrate cleaning tank for containing the substrate and receiving a vaporized drying fluid; and
a vapor concentration detector provided in fluid communication with said substrate cleaning tank for measuring a concentration of the vaporized drying fluid in said substrate cleaning tank.

2. The system of claim 1 further comprising an alarm operably connected to said vapor concentration detector for indicating abnormal levels of the concentration of the vaporized drying fluid in said substrate cleaning tank.

3. The system of claim 1 further comprising a fluid container confluently connected to said substrate cleaning tank for containing and vaporizing the vaporized drying fluid and wherein said substrate cleaning tank receives the vaporized drying fluid from said fluid container.

4. The system of claim 3 further comprising an alarm operably connected to said vapor concentration detector for indicating abnormal levels of the concentration of the vaporized drying fluid in said substrate cleaning tank.

5. The system of claim 3 further comprising a heating system operably connected to said fluid container for heating the drying fluid and controlling the concentration of the vaporized drying fluid in said substrate cleaning tank.

6. The system of claim 5 further comprising an alarm operably connected to said vapor concentration detector for indicating abnormal levels of the concentration of the vaporized drying fluid in said substrate cleaning tank.

7. The system of claim 5 wherein said heating system comprises a heating ring provided in thermal engagement with said fluid container for receiving a heating liquid and a temperature controller operably connected to said heating ring for controlling a temperature of the heating liquid.

8. The system of claim 7 further comprising a temperature buffer tank provided in fluid communication with said heating ring for stabilizing the temperature of the heating liquid.

9. A system for drying a substrate, comprising:
a fluid container for containing and vaporizing a drying fluid;
a substrate cleaning tank provided in confluent communication with said fluid container for containing the substrate and receiving the vaporized drying fluid;
a vapor concentration detector provided in fluid communication with said substrate cleaning tank for measuring a concentration of the vaporized drying fluid in said substrate cleaning tank; and
a temperature controller operably connected to said vapor concentration detector for receiving a signal indicating a concentration of the vaporized drying fluid in said substrate cleaning tank and operably connected to said fluid container for controlling a temperature of the drying fluid in said fluid container.

10. The system of claim 9 further comprising a conduit for transporting a heated liquid, a heating ring provided in thermal engagement with said fluid container and in fluid communication with said conduit for receiving the heated liquid from said conduit, and a flow valve provided in said conduit for controlling flow of the heated liquid through said conduit; and wherein said temperature controller is operably connected to said heating ring for heating said heating ring and controlling a temperature of the heated liquid.

11. The system of claim 10 further comprising a solenoid valve provided in pneumatic communication with said flow valve and wherein said temperature controller is operably connected to said solenoid valve for opening said solenoid valve and facilitating flow of air through said solenoid valve to said flow valve for closing said flow valve when the concentration of the vaporized drying fluid in said substrate cleaning tank exceeds an upper limit.

12. The system of claim 11 further comprising a temperature buffer tank provided in said conduit for stabilizing the temperature of the heated liquid.

13. A method of controlling a concentration of a vaporized drying fluid in a substrate cleaning tank, comprising the steps of:
providing a drying fluid container containing a liquid drying fluid in confluent communication with the substrate cleaning tank; and
obtaining the vaporized drying fluid from the liquid drying fluid and distributing the vaporized drying fluid to the substrate cleaning tank by maintaining the liquid drying fluid within a selected temperature range in said drying fluid container.

14. The method of claim 13 wherein said liquid drying fluid is liquid isopropyl alcohol.

15. The method of claim 14 wherein said selected temperature range is from about 18° C. to about 30° C.

16. The method of claim 13 wherein said maintaining the liquid drying fluid within a selected temperature range in said drying fluid container comprises the steps of providing a heating ring in thermal engagement with said drying fluid container; circulating a heating liquid through said heating ring; operably connecting a temperature controller to said heating ring; and maintaining the heating liquid within said selected temperature range using said temperature controller.

17. The method of claim 16 wherein said circulating a heating liquid through said heating ring comprises the steps of providing a conduit in fluid communication with said heating ring; providing a flow valve in said conduit; and distributing the heating liquid from said conduit to said heating ring.

18. The method of claim 17 further comprising the steps of measuring the concentration of the vaporized drying fluid in the substrate cleaning tank by providing a vapor concentration detector in fluid communication with the substrate cleaning tank, operably connecting said temperature controller to said vapor concentration detector, operably connecting said temperature controller to said flow valve, transmitting a signal indicating the concentration of the vaporized drying fluid from said vapor concentration detector to said temperature controller, and terminating distribution of the heating liquid from said conduit to said heating ring by closing said flow valve by operation of said temperature controller when said concentration of the vaporized drying fluid exceeds an upper vapor concentration limit.

19. The method of claim 18 wherein said liquid drying fluid is liquid isopropyl alcohol.

20. The method of claim 19 wherein said selected temperature range is from about 18° C. to about 30° C. and said upper vapor concentration limit is about 20,000 ppm.
